(19) United States
(12) Patent Application Publication
(10) Pub. No.: US 2020/0221622 A1
(43) Pub. Date: Jul. 16, 2020

(54) EARTHWORKING TINE AND METHOD OF MANUFACTURE

(71) Applicant: Myers Spring Co., Inc., Logansport, IN (US)

(72) Inventor: Arthur Todd Miller, Logansport, IN (US)

(21) Appl. No.: 16/244,305

(22) Filed: Jan. 10, 2019

(51) Int. Cl. A01B 23/02; A01B 35/24

(52) U.S. Cl. CPC A01B 23/02; A01B 19/02; A01B 35/24

(57) ABSTRACT

This present disclosure relates to an earthworking tine and method of manufacture. More particularly the disclosure is directed to a earthworking tine with a hardened end and related methods. Specifically, the disclosure relates to an earthworking tine with an indicator layer to indicate wear and potential tine failure before failure occurs.

### TECHNICAL FIELD

This present disclosure relates to an earthworking tine and method of manufacture. More particularly the disclosure is directed to a earthworking tine with a hardened end and related methods. Specifically, the disclosure relates to an earthworking tine with an indicator layer to indicate wear and potential tine failure before failure occurs.

### BACKGROUND

### Background Information

A spring harrow is a traditional farm implement featuring a frame that is towed over the ground by an agricultural tractor so that a set of spring tines depending downward from the frame engage the ground surface to break up and smooth out the same.

Common types of spring harrows employ a double coil spring tine, where a pair of horizontally spaced apart coils wind around a shared horizontal axis with inner ends of the coils joined together by a central cross-bar running parallel to that axis. Then, a pair of tine shafts extend downwardly from the outer ends of the two coils. A central cross-bar is mounted to the implement frame and the coils independently and respectively bias the two tine shafts downward about the coil axis to keep the lower ends of the tine shafts engaged with the ground.

### SUMMARY

A known problem with spring tines is they may tend to wear relatively quickly, and accordingly require frequent replacement. The tines themselves are relatively cheap, however, when a tine is about to break, there is no early warning system in place. Additionally, if the tine breaks in the field, it is not always readily apparent. As such, the broken tine may find itself puncturing a hole in a very expensive farm tractor tire or being a hazard within the field. As such, tines may be improved and strengthened in a variety of ways.

In one aspect, the present disclosure may provide for a spring harrow comprising at least one spring, at least one downwardly extending member having an upper portion and a lower portion and having a longitudinal axis extending therebetween; said upper portion of the downwardly extending member is in contact with the at least one spring and said lower portion terminating in a distal tip, a hardened layer at an outer surface extending around a perimeter of the lower portion terminating at the distal tip of the lower portion, wherein the hardened layer is a laser clad hardened material, wherein the laser clad hardened material is operative to create a hardened wear zone. This exemplary embodiment or another exemplary embodiment may further provide for a transition zone, wherein the transition zone is located longitudinally between the upper portion and lower portion. This exemplary embodiment or another exemplary embodiment may further provide for the transition zone which is operative to transition from the upper circular portion in cross section to the lower non-circular shape in cross section. This exemplary embodiment or another exemplary embodiment may further provide for the lower portion to include an interior body, wherein the interior body is located underneath the laser clad hardened material. This exemplary embodiment or another exemplary embodiment may further provide for the lower portion to further include a shoulder extending radially inward towards the longitudinal axis from the interior body of the lower portion, wherein when the laser clad hardened material added to the shoulder, the hardened material is operative to sit essentially flush with the shape of upper portion of the tine. This exemplary embodiment or another exemplary embodiment may further provide for the lower portion of the tine further includes an indicator layer located between the interior body and the outer surface. This exemplary embodiment or another exemplary embodiment may further provide for the indicator layer as a distinct different color than that of the hardened portion. This exemplary embodiment or another exemplary embodiment may further provide for the laser clad hardened material is in a range from about 30 to about 60 thousandths of an inch thick. This exemplary embodiment or another exemplary embodiment provides that the upper portion is circular shape in cross section and the lower portion has a non-circular shape in cross section. This exemplary embodiment or another exemplary embodiment may further provide for the lower portion of the tine to be of a diamond shape, square shape, pentagonal shape, oval shape, rectangular shape, or triangular shape when viewed in cross section. This exemplary embodiment or another exemplary embodiment may further provide for the lower portion of the tine further includes: an indicator layer located between the lower portion of the tine and the outer surface. This exemplary embodiment or another exemplary embodiment may further provide for the indicator layer to be operative to provide a visual indicator to a user that the tine is broken and needs replaced when the hardened layer is fractured, cut, broken or otherwise perforated. This exemplary embodiment or another exemplary embodiment may further provide for the indicator layer is a distinct different color than that of the outer surface.

In one aspect, the present disclosure may provide for a spring harrow comprising at least one spring, at least one downwardly extending member having an upper portion and a lower portion and having a longitudinal axis extending therebetween; said upper portion of the downwardly extending member is in contact with the at least one spring and said lower portion terminating in a distal tip, a hardened layer at an outer surface extending around a perimeter of the lower portion terminating at the distal tip of the lower portion, wherein the hardened layer is a laser clad hardened material, wherein the laser clad hardened material is operative to create a hardened wear zone. This exemplary embodiment or another exemplary embodiment may further provide for a transition zone, wherein the transition zone is located longitudinally between the upper portion and lower portion. This exemplary embodiment or another exemplary embodiment may further provide for the transition zone which is operative to transition from the upper circular portion in cross section to the lower non-circular shape in cross section. This exemplary embodiment or another exemplary embodiment may further provide for the lower portion to include an interior body, wherein the interior body is located underneath the laser clad hardened material. This exemplary embodiment or another exemplary embodiment may further provide for the lower portion to further include a shoulder extending radially inward towards the longitudinal axis from the interior body of the lower portion, wherein when the laser clad hardened material added to the shoulder, the hardened material is operative to sit essentially flush with the shape of upper portion of the tine. This exemplary embodiment or another exemplary embodiment may further provide for the lower portion of the tine further includes an indicator layer located between the interior body and the outer surface. This exemplary embodiment or another exemplary embodiment may further provide for the indicator layer as a distinct different color than that of the hardened portion. This exemplary embodiment or another exemplary embodiment may further provide for the laser clad hardened material is in a range from about 30 to about 60 thousandths of an inch thick. This exemplary embodiment or another exemplary embodiment provides that the upper portion is circular shape in cross section and the lower portion has a non-circular shape in cross section, This exemplary embodiment or another exemplary embodiment may further provide for the lower portion of the tine to be of a diamond shape, square shape, pentagonal shape, oval shape, rectangular shape, or triangular shape when viewed in cross section. This exemplary embodiment or another exemplary embodiment may further provide for the lower portion of the tine further includes: an indicator layer located between the lower portion of the tine and the outer surface. This exemplary embodiment or another exemplary embodiment may further provide for the indicator layer to be operative to provide a visual indicator to a user that the tine is broken and needs replaced when the hardened layer is fractured, cut, broken or otherwise perforated. This exemplary embodiment or another exemplary embodiment may further provide for the indicator layer is a distinct different color than that of the outer surface.

In another aspect, the disclosure may provide for an article of manufacture comprising; at least one spring, at least one downwardly extending member having an upper portion and a lower portion and having a longitudinal axis extending therebetween; said upper portion of the downwardly extending member is in contact with the at least one spring, wherein the transition zone is operative to transition from the circular shape to the non-circular shape, an inwardly defined shoulder of the lower portion, and the lower portion is defined by a cutting surface on the front of the lower portion deigned to make contact with a ground surface and a non-cutting surface on the rear of a tine; a distinct material layer of the lower portion, wherein the distinct material is operative to create a hardened wear zone, and wherein the hardened material has a thickness equal to that of the inwardly defined shoulder so as to be positioned to sit flush with the upper portion. This exemplary embodiment or another exemplary embodiment may further provide the distinct material is in a range from about 30 to about 60 thousandths of an inch thick. This exemplary embodiment or another exemplary embodiment provides that the upper portion is circular shape in cross section and the lower portion has a non-circular shape in cross section This exemplary embodiment or another exemplary embodiment may further provide for the lower portion of the tine to be of a diamond shape, square shape, pentagonal shape, oval shape, rectangular shape, or triangular shape. This exemplary embodiment or another exemplary embodiment may further provide for the lower portion of the tine further includes: an indicator layer located between the lower portion of the tine and the outer surface. This exemplary embodiment or another exemplary embodiment may further provide for the indicator layer is operative to provide a visual indicator to a user that the tine is broken and needs replaced when the hardened layer is fractured, cut, broken or otherwise perforated.

In another aspect, the disclosure may provide for a method for installing a tine onto an earthworking machine, wherein the tine comprises at least one spring, at least one downwardly extending member having an upper portion and a lower portion and having a longitudinal axis extending therebetween; said upper portion of the downwardly extending member is in contact with the at least one spring and said lower portion terminating in a distal tip, a hardened layer at an outer surface extending around a perimeter of the lower portion terminating at the distal tip of the lower portion, wherein the hardened layer is a laser clad hardened material, wherein the laser clad hardened material is operative to create a hardened wear zone; and an indicator layer, located between the outer surface of the hardened material layer and the outer surface of the lower portion, wherein the indicator layer is operative to provide a visual indicator to a user that the lower portion of the tine is worn, broken, fractured or otherwise needs replaced, operating the earthworking machine with the installed tine, exposing the indicator layer as a result of operating the installed tine on one or more surfaces of the tine, viewing the exposed indicator layer, removing and disposing the tine in response to viewing the exposed indicator layer; and replacing the tine with the exposed indicator layer for another tine without an exposed indicator layer. This exemplary embodiment or another exemplary embodiment may further provide for exposing the indicator layer further including displaying the indicator layer while the lower portion remains intact. This exemplary embodiment or another exemplary embodiment may further provide for the indicator layer is a distinct different color than that of the outer surface.

In another aspect, the disclosure may provide for a method for installing a tine onto an earthworking machine, wherein the tine comprises at least one spring, at least one downwardly extending member having an upper portion and a lower portion and having a longitudinal axis extending therebetween; said upper portion of the downwardly extending member is in contact with the at least one spring and said lower portion terminating in a distal tip, a hardened layer at an outer surface extending around a perimeter of the lower portion terminating at the distal tip of the lower portion, wherein the hardened layer is a distinct material, wherein the distinct material is operative to create a hardened wear zone; and an indicator layer, located between the outer surface of the hardened material layer and the outer surface of the lower portion, wherein the indicator layer is operative to provide a visual indicator to a user that the lower portion of the tine is worn, broken, fractured or otherwise needs replaced, operating the earthworking machine with the installed tine, exposing the indicator layer as a result of operating the installed tine on one or more surfaces of the tine, viewing the exposed indicator layer, removing and disposing the tine in response to viewing the exposed indicator layer; and replacing the tine with the exposed indicator layer for another tine without an exposed indicator layer. This exemplary embodiment or another exemplary embodiment may further provide for exposing the indicator layer further including displaying the indicator layer while the lower portion remains intact. This exemplary embodiment or another exemplary embodiment may further provide for the indicator layer is a distinct different color than that of the outer surface.

In another aspect, the disclosure may provide for an earth engaging member comprising: at least one downwardly extending member having an upper portion and a lower portion and having a longitudinal axis extending therebetween; said lower portion terminating in a distal tip, a hardened layer defining an outer surface extending along a portion of the lower portion terminating at the distal tip of the lower portion, wherein the hardened layer is a distinct material separate from the lower portion of the member, wherein the distinct material is operative to create a hardened wear zone.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a perspective view of an exemplary hardened tine.

FIG. 2A is a longitudinal cross section view of a hardened tine across line 2A in FIG. 1.

FIG. 2B is an alternative embodiment longitudinal cross section view of a hardened tine with an indicator layer across line 2B in FIG. 1.

FIG. 3A is a bottom side cross section view of a hardened tine across line 3A in FIG. 1.

FIG. 3B is an alternative embodiment bottom side cross section view of a hardened tine with an indicator layer across line 3B in FIG. 1.

FIG. 4 is a perspective view of an exemplary tine with part of the hardened tine worn away exposing an indicator layer.

FIG. 5A is a cross sectional view of an exemplary partially hardened tine on a diamond shaped cutting end.

FIG. 5B is a cross sectional view of an exemplary fully hardened tine with a square shaped base.

FIG. 5C is a cross sectional view of an exemplary partially hardened tine with a triangular shaped base.

FIG. 5D is a cross sectional view of an exemplary partially hardened tine with an indicator layer with a hexagonal shaped base.

FIG. 5E is a cross sectional view of an exemplary fully hardened tine with an oval shaped base.

FIG. 5F is a cross sectional view of an exemplary fully hardened tine with a square shaped base.

Similar numbers refer to similar parts throughout the drawings.

### DETAILED DESCRIPTION

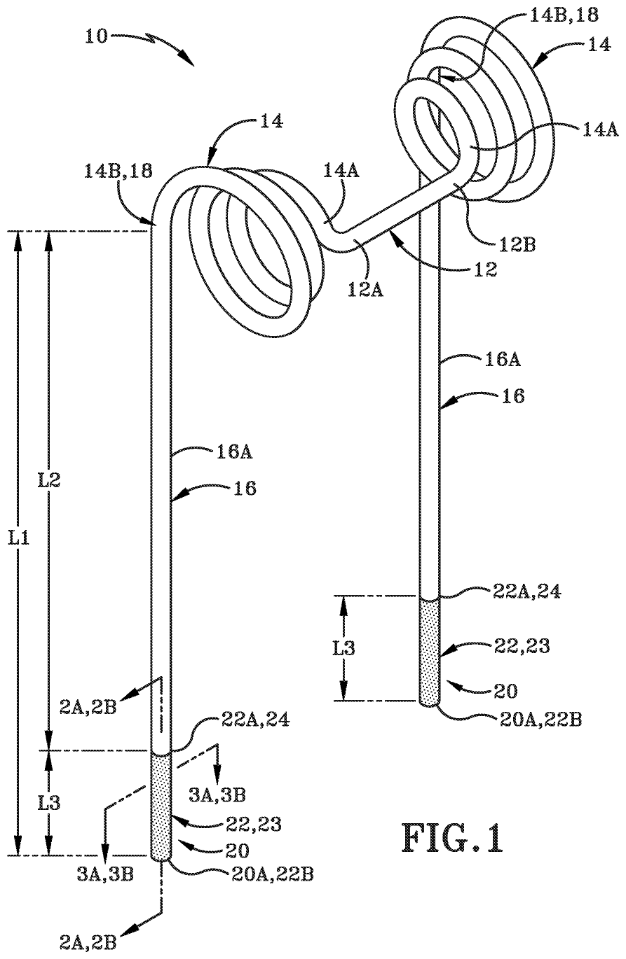

Referring now to the drawings, FIG. 1 there is shown an exemplary tine 10. Exemplary tine includes a cross member 12 with a first end 12A and a second end 12B. The cross member 12 extends longitudinally between a pair of coil springs 14. The cross member 12 is attached to each of the coil springs 14 at a respective end. Each of the coil springs 14 share a horizontal axis and are joined at their inner ends 14A by the respective cross member end 12A, 12B disposed parallel to that axis. The exemplary tine 10 extends downwardly from each of the coil springs 14 their outer ends 14B to a shaft 16. In the exemplary tine, the shaft is generally cylindrical in shape. It can be appreciated that the shaft 16 in this embodiment is depicted as entirely cylindrical, but may be various lengths, shapes and diameters as desired which will be discussed later. The shaft 16 has an upper end 18 and a lower end 20 and a length L1. The upper end 18 is disposed downwardly with respect to the coil springs 14. The lower end 20 is disposed downwardly of the upper end 18. At the lower end 20 of the tine 10, there is a hardened end 22 extending around a perimeter at a portion of the lower end 16 of the shaft with a length L3, with a top portion of the hardened end 22A and a lower portion of the hardened end 22B. The portion of the shaft above the hardened end 22 is a machined portion 16A with a length L2. The hardened end 22 of the tine 10 is downwardly extending and is operative to engage with dirt, soil or other surfaces. At the top portion of the hardened end 22A, there exists a radially inward shoulder 24 which will be discussed later. It may be understood by viewing this figure that there are two separate portions of the tine on each side of the spring, this view is merely exemplary and may include multiple springs 14, shafts 16, etc. as needed. An exemplary tine may have at least one downwardly extending hardened end 22 at a tip of the lower end of the shaft 20A. The hardened end 22 includes a hardened layer 23 later discussed.

Exemplary embodiments provide for the ratio of the lengths of L1 to L3 to be about 2:1 to about 6:1. For example, when L1 is about 15 inches in length, L3 may be between about 2.5 and about 7.5 inches in length. Further exemplary embodiments provide for a ratio of L1 to L3 to be about 2:1 to about 4:1. For example, when L1 is about 15 inches in length, L3 may be between about 3.75 to about 7.5 inches in length. A further exemplary embodiment provides for a ratio of 3:1. For example, when L1 is about 15 inches in length, L3 may be between about 5 inches in length.

Further, while the tine 10 is configured to be constructed as a unibody, monolithic, single member formed from a unitary material, portions of the tine 10 will be described with references to other portions thereof and may be described with different references, but physically constructed from the same material. For example, the tine 10 may be fabricated from a single piece, wire or rod of metal material so as to define the structural relationships described herein.

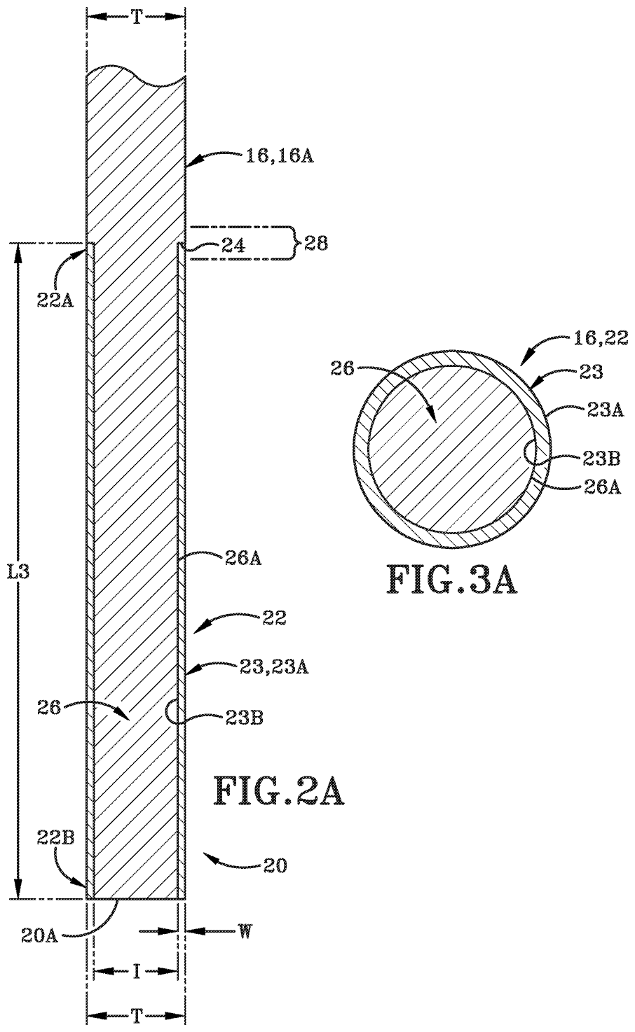

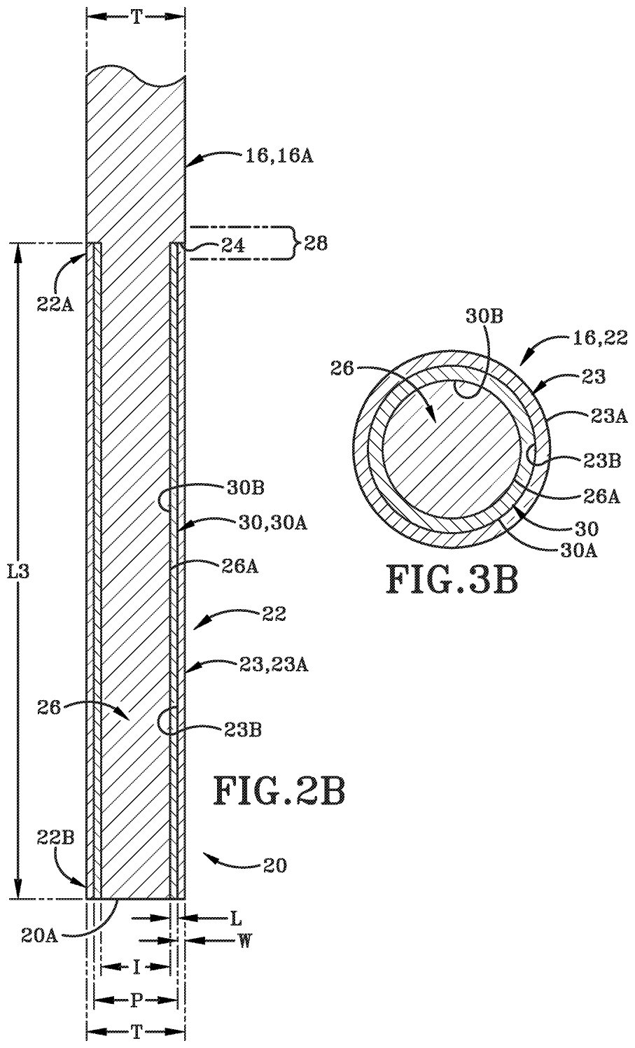

Referring now to FIG. 2A, a longitudinal cross section of a lower end of the shaft 20 of an exemplary tine 10 is shown along line 2A-2A in FIG. 1. This circular cross section is shown on the lower end of the shaft 20 at a top portion 22A of the hardened end 22 at a transition zone 28 between the lower end of the shaft 20 defining an interior body 26 and the hardened portion 22 and above the lower end of the hardened portion 22B and the tip 20A. The hardened portion 22 includes a hardened layer 23, which includes an outer surface 23A and an inner surface 23B. In the absence of the hardened end 22, shaft 16 contains a shoulder 24 extending inwardly in the transition zone 28 between the portion of the lower end of the shaft 20 and the shaft 16 and the machined portion of the shaft 16A of the tine wherein the shoulder has a width “W”. When the tine is circular in cross section, as it is in this embodiment, the width is equal to the diameter. Additionally, the width of the hardened layer 23 also has a width “W” The interior body 26 is defined by a width at the bottom of the tine 10 “I”. The width of “I” and “W” added together equal the total width of the tine “T”. The top portion 22A of the hardened portion 22 is operative to sit essentially flush with the lower end of the shaft 20.

Referring now to FIG. 3A shown along line 3A-3A in FIG. 1, a circular cross section view of an exemplary tine 10 along the shaft 16 at the lower end of the shaft 20 is shown at the hardened end 22. In this view, one may see the hardened portion 22 and the hardened layer 23. The hardened layer 23 has an outer surface 23A radially outward from an inner surface 23B. Additionally, the interior body 26 is shown. The interior body 26 has an outer surface 26A. As can be seen, the outer surface of the interior body 26A is in radial contact and directly abuts the inner surface of the hardened layer 23B.

Referring now to FIG. 2B, a longitudinal cross section of a second embodiment of an exemplary tine 10 is shown along line 2B-2B in FIG. 1. This circular cross section is shown on the lower end of the shaft 20 at a top portion 22A of the hardened end 22 at a transition zone 28 between the lower end of the shaft 20 defining an interior body 26 and an indicator layer 30 between the hardened portion 22 and the interior body 26 and the hardened portion 22 and above the lower end of the hardened portion 22B and the tip 20A. The hardened portion 22 includes a hardened layer 23, which includes an outer surface 23A and an inner surface 23B. Similarly, the indicator layer 30 includes an outer surface 30A and an inner surface 30B. Similar to the first embodiment, in the absence of the hardened end 22, shaft 16 contains a shoulder 24 extending inwardly in the transition zone 28 between the portion of the lower end of the shaft 20 and the shaft 16 of the tine has a width “W”. An interior body 26 is defined by a width at the bottom of the tine 10 “I”. The width of the indicator layer 30 is defined by “L”. The indicator layer 30 and the interior body 26 is defined by letter “P”. The width of “I”, “L” and “W” added together equal the total width of the tine “T”. The top end of the hardened portion 22A is operative to sit essentially flush with the lower end of the shaft 20.

Referring now to FIG. 3B, a cross section view is shown along line 3B-3B in FIG. 1, is shown of a second embodiment of a tine 10 along the shaft 16 at the lower end of the shaft 20 is shown at the hardened end 22. In this view, one may see the hardened portion 22, the hardened layer 23 and the indicator layer 30. Additionally, the interior body 26 is shown. As can be seen, the outer surface of the interior body 26A is in radial contact and directly abuts the inner surface of the indicator layer 30B. The outer surface of the indicator layer 30A then is in radial contact and directly abuts the inner surface of the hardened layer 23B.

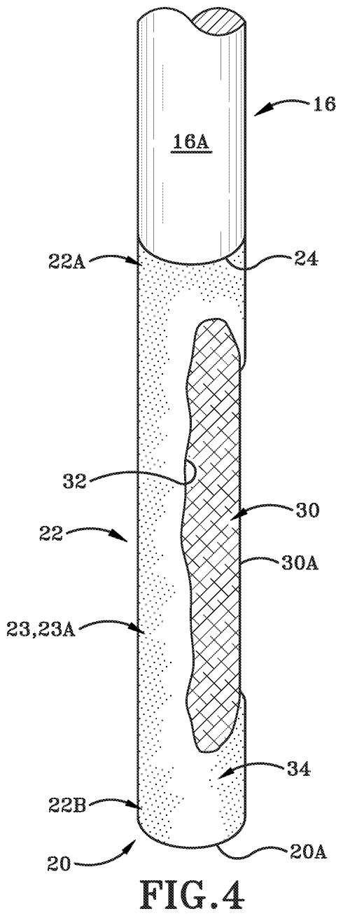

Referring now to FIG. 4, an exemplary tine 10 with a worn out surface area 32 is shown. The shaft 16 and in particular a lower portion of the shaft 20 is shown with an exposed outer surface 30A of the indicator layer 30. However, other portions of a cutting surface 34 remain.

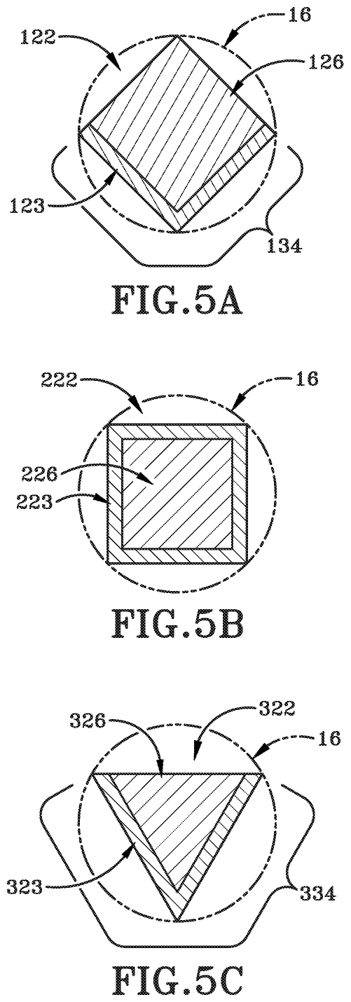

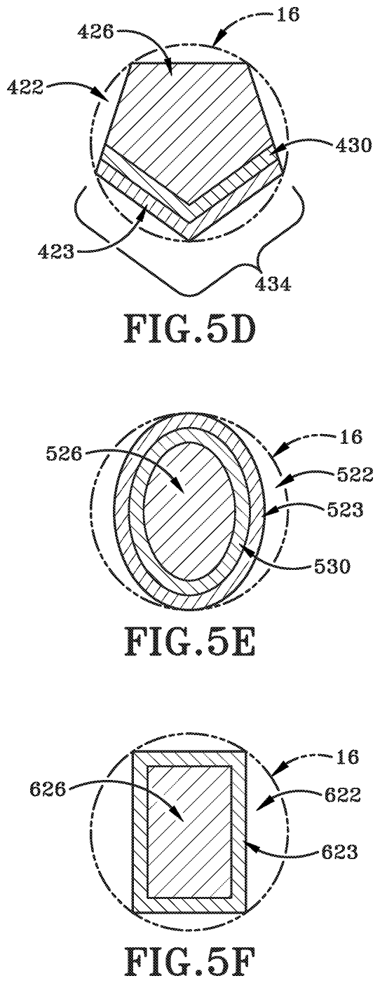

Referring now to FIG. 5A, an alternative embodiment is shown of a cross sectional view of an exemplary triangular shaped tine. In the alternative embodiment, the general construction remains the same as the previous embodiments, but the hardened end 122 of a tine 10 may only cover a partial surface, or a cutting surface 134, of a tine 10 rather than entirely encompassing it, as in previous embodiments. Similar to the first embodiment, the tine still has a shoulder 24 on the interior body 126, wherein the width of the shoulder plus that of the hardened area 123, equals the width of the tine as a whole, but the shoulder only extends on a partial side, the same side as the hardened end 123. The remaining portion of the lower portion of a tine 20 that the hardened end 122 does not extend, the surface of the lower end of tine 20 sits substantially flush with the rest of the tine. In further alternative embodiments, other shapes of the end tine may be used as well. It should be understood that the shaft 16 is generally circular in cross section but may be adequately machined to allow the hardened end 122 of a tine to be various shapes in nature such as diamond shape when viewed in cross section in this embodiment.

Referring now to FIG. 5B, an alternative embodiment is shown of a cross sectional view of an exemplary square shaped tine. The shaft 16 of the tine 10 may taper from a generally circular shape at the upper end of the shaft 18 of a tine, to a transition zone transitioning at the lower end 20 to other shapes such as the square shape when viewed in radial cross section. In the alternative embodiment, the general construction remains the same as the previous embodiments, with an interior body 226 on the inside of a hardened layer 223 on a hardened end 222. Likewise to the previous embodiment, the shaft 16, is formed into a square shape when viewed in cross section.

Referring now to FIG. 5C, an alternative embodiment is shown of a cross sectional view of an exemplary triangle shaped tine. The shaft 16 of the tine 10 may taper from a generally circular shape at the upper end of the shaft 18 of a tine, to a transition zone transitioning at the lower end 20 to other shapes such as the triangular shape when viewed in radial cross section. In the alternative embodiment, the general construction remains the same as the previous embodiment, but similar to FIG. 5A, but the hardened end 322 of a tine 10 may only cover a partial surface, or a cutting surface 334, of a tine 10 rather than entirely encompassing it, as in previous embodiments. Similar to the first embodiment, the tine still has a shoulder 24 on the interior body 326, wherein the width of the shoulder plus that of the hardened area 323, equals the width of the tine as a whole, but the shoulder only extends on a partial side, the same side as the hardened end layer 323. The remaining portion of the lower portion of a tine 20 that the hardened end 322 does not extend, the surface of the lower end of tine 20 sits substantially flush with the rest of the tine.

Referring now to FIG. 5D, an alternative embodiment is shown of a pentagonal shaped in cross section tine 10. The shaft 16 of the tine 10 may taper from a generally circular shape at the upper end of the shaft 18 of a tine, to a transition zone transitioning at the lower end 20 to other shapes such as the pentagonal shape when viewed in radial cross section. In this alternative embodiment, there exists an indicator layer 430, between the interior body 426 and cutting surface 434. The hardened end 422 of a tine 10 may only cover a partial surface, or a cutting surface 434, of a tine 10 rather than entirely encompassing it, as in previous embodiments. Similar to other embodiments, the tine 10 still has a shoulder 24 on the interior body 426, wherein the width of the shoulder plus that of the hardened end 422, and indicator layer 430 equals the width of the tine as a whole, but the shoulder only extends on a partial side, the same side as the hardened end layer 423 and indicator 430. The remaining portion of the lower portion of a tine 20 with the hardened end 422 and indicator layer 430 does not extend, the surface of the lower end of tine 20 sits substantially flush with the rest of the tine.

Referring now to FIG. 5E, an alternative embodiment is shown of a cross sectional view of an exemplary oval shaped base of a tine 10 is shown. In the alternative embodiment, the general construction remains the same as the previous embodiment, but in this embodiment, there is an indicator layer 530 surrounding the interior body 526, as well as a hardened end layer 523 at the hardened end 522 that surrounds the indicator layer 530.

Referring now to FIG. 5F, an alternative embodiment is shown of cross sectional view of an exemplary fully hardened tine with a rectangular in cross section shaped base are shown. The shaft 16 of the tine 10 may taper from a generally circular shape at the upper end of the shaft 18 of a tine, to a transition zone transitioning at the lower end 20 to other shapes such as the rectangular shape when viewed in radial cross section. In the alternative embodiment, the general construction remains the same as the previous embodiments, with an interior body 626 on the inside of a hardened layer 623 on a hardened end 622.

These exemplary embodiments are merely examples and other shapes may be used. In these embodiments, the hardened material surrounds the tine in all directions. However, in other embodiments discussed later it may be appropriate for only the surface end which is to be in contact with the ground, soil, dirt, etc., may be coated in the hardened material.

In all embodiments, multiple shapes of exemplary lower end 16 of the tine 10 may be implored. The tine 10 is relatively cylindrically shaped on the upper end of the shaft 18 and may taper into another shape at the lower end the shaft 20 and tine 10. Shape consideration may be chosen in response to effects occurring during seedbed or field preparation. These effects may include, but are not limited to the incorporation of seeds, fertilizers and granulated chemicals, methods of mechanical weed control in place, variation of particle properties within the seedbed or field, density of the soil, traveling speed of the tine, and moisture content of the soil involved. Shapes may be chosen from multiple options, including but not limited to, circle, oval, square, rectangular, pentagonal, etc. As such, shapes are not limited to those seen and described herein. In some embodiments, the lower end of the shaft may be tapered over a long distance of a transition zone 28. In other embodiments, the lower end of the shaft 20 may be machined away in some method to create a transition zone 28 and shoulder 24 that are one in the same.

In exemplary embodiments the width of “W” may be in a range of between about 30 and about 60 thousandths of an inch deep. In further exemplary embodiments the width may be smaller, or larger depending on the desired soil type, including the amount of rocks, chaff and other debris within the field. Strengthening material is then applied so that it is essentially flush with the lower end of the shaft 20 of the material so that a shelf is not created to collect chaff and debris as the tine 10 moves through a field.

In exemplary embodiments, the hardened end 22 is hardened by processing the end with laser cladding. Laser cladding is a method of depositing material by which a powdered or wire feedstock material is melted and consolidated by use of a laser in order to coat part or all of a substrate with a fused material. Generally, the powder or wire feedstock used in laser cladding is normally of a metallic nature, and is injected into the system by either coaxial or lateral nozzles. The interaction of the metallic powder stream or wire and the laser causes localized melting to occur, and is known as the melt pool. The powder is feedstock is thusly deposited onto a substrate, all while moving the substrate and allowing the melt pool to solidify and thus produce a track of solid metal on the substrate. While this is the most common technique of laser cladding, other processes involve moving the laser and nozzle assembly over a stationary substrate to produce solidified tracks; wherein the motion of the substrate is guided by a CAD (Computer-Aided Design) system which interpolates solid objects into a set of tracks, thus producing the desired part at the end of the trajectory of the path.

Laser cladding is operative to give the coated portion of substrate superior properties when compared to other hard facing techniques. Laser cladding allow for a low dilution between the track and substrate, low levels of deformation between the substrate, substantially free of any crack and porosity, a high cooling rate (which in turn leads to a fine microstructure), a small heat affected zone, increased corrosion resistance and higher strength of the part which has been laser cladded.

In certain embodiments, the laser cladding is applied by a method which includes resting the uncladded tine on a support structure, positioning the tine within the support structure which is operative to hold the tine in a horizontal position or, alternatively, may be adjusted to change the orientation or angle of the tine relative to the support structure, aligning the tine with the laser and injector, melting and simultaneously depositing the laser clad material onto the tine while moving the tine or the support structure in a pathway along the tine and depositing laser clad material onto tine along the pathway until the entire surface desired to be laser clad is covered.

Additionally, through various experimentation, it is possible determine the length of life for the hardened layer of the tine. This length of wear would be different for various soil types. Therefore, it would be possible to measure the tine width at the hardened material in an iterative manner and noting that whenever the laser cladding reaches a certain thickness or depth, the tine should be replaced rather than waiting until it breaks.

An exemplary method provides for installing an exemplary tine on an earthworking machine, operating the earthworking machine with the installed tine, exposing the indicator layer as a result of operating the installed tine on one or more surfaces of the tine, viewing the exposed indicator layer, removing and disposing the tine in response to viewing the exposed indicator layer, and replacing the tine with the exposed indicator layer for another tine without an exposed indicator layer.

Exemplary embodiments relate to an earthworking tine with an inwardly shaped shoulder has been laser cladded in order to sit flat and create a hardened wear zone. In alternative embodiments relate to an earthworking tine with a portion of the underlying tine shaped into different shapes. A further alternative embodiment relates to an earthworking tine which has been laser cladded and prior to laser cladding an indicator layer operative to indicate wear of the tine is applied.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An earth engaging member comprising:
at least one downwardly extending member having an upper portion and a lower portion and having a longitudinal axis extending therebetween; said lower portion terminating in a distal tip;
a hardened layer defining an outer surface extending along a portion of the lower portion terminating at the distal tip of the lower portion, wherein the hardened layer is a distinct material separate from the lower portion of the member, wherein the distinct material is operative to create a hardened wear zone, wherein the lower portion includes an interior body located radially inward of the hardened layer relative to the longitudinal axis; and
an indicator layer located between the interior body and the outer surface.

2. The earth engaging member tine of claim 1, wherein the indicator layer is operative to provide a visual indicator to a user that the tine needs replaced.

3. The earth engaging member tine of claim 1, and further comprising at least one spring, wherein the upper portion of the downwardly extending member is in contact with the at least one spring.

4. The earth engaging member of claim 1, wherein the lower portion further includes:
a shoulder extending radially inward from the interior body of the lower portion, wherein when the distinct material added to the shoulder, the distinct material is essentially flush with the shape of upper portion of the tine.

5. The earth engaging member of claim 1, wherein the hardened layer is a laser clad layer.

6. The earth engaging member of claim 1, and further comprising a cutting surface portion, defined by the portion of the earth engaging member that is the hardened layer.

7. The earth engaging member of claim 1, and further comprising a non-cutting layer portion, defined by the portion of the earth engaging member that is not covered by the hardened layer.

8. The earth engaging member of claim 1, wherein the indicator layer is a distinct different color than that of the distinct material of the hardened layer.

9. The earth engaging member of claim 1, wherein the distinct material is in a range of about 30 to about 60 thousandths of an inch thick.

10. The earth engaging member of claim 1, further comprising, a transition zone, wherein the transition zone is located longitudinally between the upper portion and lower portion.

11. The earth engaging member of claim 10, wherein the transition zone is operative to transition from a circular shape in cross section at the upper portion to a non-circular shape in cross section at the lower portion.

12. The earth engaging member of claim 11, wherein the non-circular shape of lower portion of the tine is one of a diamond shape, square shape, pentagonal shape, oval shape, rectangular shape, or triangular shape in cross section.

13. An earth engaging member comprising:
at least one downwardly extending member having an upper portion and a lower portion and having a longitudinal axis extending therebetween said lower portion terminating in a distal tip;
a transition zone between the upper portion and lower portion, wherein the transition zone includes;
an inwardly defined shoulder of the lower portion, and the lower portion is defined by a cutting surface on the front of the lower portion deigned to make contact with a ground surface and a non-cutting surface on the rear of a tine;
a laser clad hardened material layer of the lower portion, wherein the laser clad hardened material is operative to create a hardened wear zone, and wherein the hardened material has a thickness equal to that of the inwardly defined shoulder positioned to sit flush with the upper portion.

14. The earth engaging member of claim 13, wherein the laser clad hardened material is in a range of about 30 to about 60 thousandths of an inch thick.

15. The earth engaging member of claim 13, wherein the transition zone is operative to transition from a circular shape in cross section at the upper portion to a non-circular shape in cross section at the lower portion, wherein the non-circular shape in cross section at the lower portion is one of a diamond shape, square shape, pentagonal shape, oval shape, rectangular shape, or triangular shape.

16. The earth engaging member of claim 13, wherein the lower portion of the tine further includes: an indicator layer located between the lower portion of the earth engaging member and the outer surface.

17. The earth engaging member of claim 16, wherein the indicator layer is operative to provide a visual indicator to a user that the earth engaging member is broken and needs replaced.

18. A method comprising:
installing a tine onto an earthworking machine, wherein the tine comprises:
at least one downwardly extending member having an upper portion and a lower portion and having a longitudinal axis extending therebetween, said lower portion terminating in a distal tip;
a hardened layer along a portion of an outer surface extending around a perimeter of the lower portion terminating at the distal tip of the lower portion, wherein the hardened layer is a distinct material, wherein the distinct material is operative to create a hardened wear zone; and an indicator layer, located between the outer surface of the hardened material layer and the outer surface of the lower portion, wherein the indicator layer is operative to provide a visual indicator to a user that the lower portion of the tine is worn, broken, fractured or otherwise needs replaced;
operating the earthworking machine with the installed tine;
exposing the indicator layer as a result of operating the installed tine on one or more surfaces of the tine;
viewing the exposed indicator layer;
removing and disposing the tine in response to viewing the exposed indicator layer; and
replacing the tine with the exposed indicator layer for another tine without an exposed indicator layer.

19. The method of claim 18, wherein exposing the indicator layer further includes,
displaying the indicator layer while the lower portion remains intact.

20. The method of claim 18, wherein the indicator layer is a distinct different color than that of the outer surface.
